(19) United States
(12) Patent Application Publication
(10) Pub. No.: US 2018/0103680 A1
(43) Pub. Date: Apr. 19, 2018

(54) METHODS AND SYSTEMS FOR IMPROVING STABILITY OF THE PRE-VAPOR FORMULATION OF AN E-VAPING DEVICE

(71) Applicant: Altria Client Services LLC, Richmond, VA (US)

(72) Inventor: Marc W. FARISS, Midlothian, VA (US)

(73) Assignee: Altria Client Services LLC, Richmond, VA (US)

(21) Appl. No.: 15/296,529

(22) Filed: Oct. 18, 2016

(51) Int. Cl. A24B 15/16; A24F 47/00; H05B 1/02

(52) U.S. Cl. CPC A24B 15/167; H05B 2203/021; H05B 1/0244; A24F 47/008

(57) ABSTRACT

A pre-vapor formulation of an e-vaping device including a vapor former configured to form a vapor, nicotine, at least one polyol compound and optionally at least one of more acids. The at least one polyol compound comprises at least one of mannitol, erythritol, xylithol and sorbitol. The pre-vapor formulation may also include chelating agents such as EDTA, DTPA and NTA. The concentration of the polyol compounds may be between about 0.2% and about 10% and the concentration of the chelating agents may be between about 0.001% and 0.05%.

### BACKGROUND OF THE INVENTION

### Field of the Invention

Some example embodiments relate generally to a pre-vapor formulation of an electronic vaping device, and/or to a method of increasing the stability of ingredients of the pre-vapor formulation.

### Related Art

Electronic vaping devices are used to vaporize a liquid material into a vapor in order for an adult vaper to draw the vapor through outlet(s) of the e-vaping device. These electronic vaping devices may be referred to as e-vaping devices. An e-vaping device may typically include several e-vaping elements such as a power supply section and a cartridge. The power supply section includes a power source such as a battery, and the cartridge includes a heater along with a reservoir capable of holding the pre-vapor formulation or liquid material. The cartridge typically includes the heater in communication with the pre-vapor formulation via a wick, the heater being configured to heat the pre-vapor formulation to produce a vapor. The pre-vapor formulation typically includes an amount of nicotine as well as a vapor former and possibly water, acids, flavorants and/or aromas. The pre-vapor formulation includes a material or combination of materials that may be transformed into a vapor. For example, the pre-vapor formulation may include a liquid, solid and/or gel formulation including, but not limited to, water, beads, solvents, active ingredients, ethanol, plant extracts, natural or artificial flavors, and/or vapor formers such as glycerin and/or propylene glycol.

In some instances, ingredients of the pre-vapor formulation in the pre-vapor formulation container may react with other ingredients, or with solid metallic parts of the pre-vapor formulation container or cartridge. For example, particularly when “dry drawing” occurs, which is when the wick of the e-vaping device is not sufficiently supplied with pre-vapor formulation prior to puff initiation by the adult vaper, if the cartridge is empty, or if a coil of the heater is overheating during operation of the e-vaping device, ingredients of the pre-vapor formulation may react with the metal(s) of the solid portions of the e-vaping device, such as copper or iron, in the presence of oxygen and generate free radicals such as, for example, hydroxyl radicals. Specifically, metal ions such as, for example, copper ions Cu²⁺, may react with oxygen or hydrogen peroxide. Alternatively, the free radicals may be generated via oxidation of the metallic portions of the cartridge or pre-vapor formulation container. The oxidation of pre-vapor formulation ingredients, the cartridge or the container is typically dependent on the presence of oxygen and a redox-active transition metal producing oxygen species such as hydroxyl radicals. The redox-active transition metal may come from metallic portions of the cartridge or container, or may be contained in other components added to the pre-vapor formulation such as nicotine, water, vapor formers such as glycerin and/or propylene glycol, acids, flavorants and/or aromas.

Accordingly, once generated, the free (e.g., hydroxyl) radicals may react with ingredients of the pre-vapor formulation, resulting in a decrease of the stability of the pre-vapor formulation. The free radicals may also mix with the vapor generated by the e-vaping device.

### SUMMARY OF THE INVENTION

At least one example embodiment relates to a pre-vapor formulation of an e-vaping device.

In one example embodiment, the pre-vapor formulation includes an additive such as at least one polyol such as mannitol, erythritol, xylithol and/or sorbitol as well as nicotine, a combination of glycerol and/or propylene glycol, optionally flavorants as well as organic acids, and the like. In example embodiments, the additive may be included in the pre-vapor formulation at a concentration in a range of, for example, about 0.2% to about 10%, and for example about 0.2% to about 2%, about 2% to about 5%, about 5% to about 8%, and about 8% to about 10% by weight.

In example embodiments, because the reaction between ingredients of the pre-vapor formulation results from the generation of hydroxyl radicals from free transition metals such as copper, nickel or iron, the addition of the polyol compounds, which are scavengers or neutralizers of hydroxyl radicals, substantially react with the free hydroxyl radicals before the free radicals can react with pre-vapor formulation ingredients, the cartridge or the pre-vapor formulation container. For example, the polyols discussed above may react with hydroxyl free radicals, thus neutralizing the oxygen species and reducing or substantially preventing oxidative reaction of pre-vapor formulation ingredients, the cartridge or pre-vapor formulation container, or reducing or substantially preventing the formation of free radicals from pre-vapor formulation ingredients. Accordingly, stability of the pre-vapor formulation is increased.

In one example embodiment, the pre-vapor formulation also includes agents that typically sequester heavy metal cations such as Cu, Fe, Ni, Cd, Zn, P, and the like. The sequestering agents may also include chelators such as ethylenediaminetetraacetic acid (EDTA), diethylene triamine pentaacetic acid (DTPA), Nitrilotriacetic acid (NTA) adsorbants, and polyelectrolyte polymers with functional groups such as carboxylic acid groups, sulfonic acid groups such as sulphonated polystyrene, quaternary amino groups such as trimethyl ammonium, and other amino groups. In example embodiments, the chelators or chelating agents such as for example, EDTA, may be included in the pre-vapor formulation at a concentration in a range of, for example, 0.001% to about 0.05%, and for example about 0.001% to about 0.01%, about 0.1% to about 0.02%, and about 0.02% to about 0.05%. For example, the sequestering agents such as the chelators discussed above may react with the free transition metals, making these metals redox-inactive and thus reduce or substantially prevent the formation of a hydroxyl free radical. As such, the free transition metals that are generated by solid portions of the e-vaping device are substantially prevented from reacting with other ingredients of the pre-vapor formulation. Accordingly, stability of the pre-vapor formulation is increased.

In example embodiments, the additives including mannitol, erythritol, xylithol and/or sorbitol, in combination with the sequestering agents such as the chelators, may increase the stability of the ingredients of the e-vaping device by sequestering, or reacting with, the free transition metals such as copper, nickel and iron present in portions of the e-vaping device, and thus substantially preventing the formation of hydroxyl radicals which may react with the ingredients of the pre-vapor formulation or may transfer to the vapor generated during operation of the e-vaping device. As a result, a greater stability of the pre-vapor formulation of an e-vaping device may be achieved.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a side view of an e-vaping device, according to an example embodiment;

FIG. 2 is a longitudinal cross-sectional view of an e-vaping device, according to an example embodiment;

FIG. 3 is a longitudinal cross-sectional view of another example embodiment of an e-vaping device; and

FIG. 4 is a longitudinal cross-sectional view of another example embodiment of an e-vaping device.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations and/or elements, but do not preclude the presence or addition of one or more other features, integers, steps, operations, elements and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%. Moreover, when the words “generally” and “substantially” are used in connection with geometric shapes, it is intended that precision of the geometric shape is not required but that latitude for the shape is within the scope of the disclosure. Although the tubular elements of the embodiments may be cylindrical, other tubular cross-sectional forms are contemplated, such as square, rectangular, oval, triangular and others.

As used herein, the term “vapor former” describes any suitable known compound or mixture of compounds that, in use, facilitates formation of a vapor and that is substantially resistant to thermal degradation at the operating temperature of the e-vaping device. Suitable vapor-formers consist of various compositions of polyhydric alcohols such as propylene glycol and/or glycerol or glycerin. In at least one embodiment, the vapor former is propylene glycol.

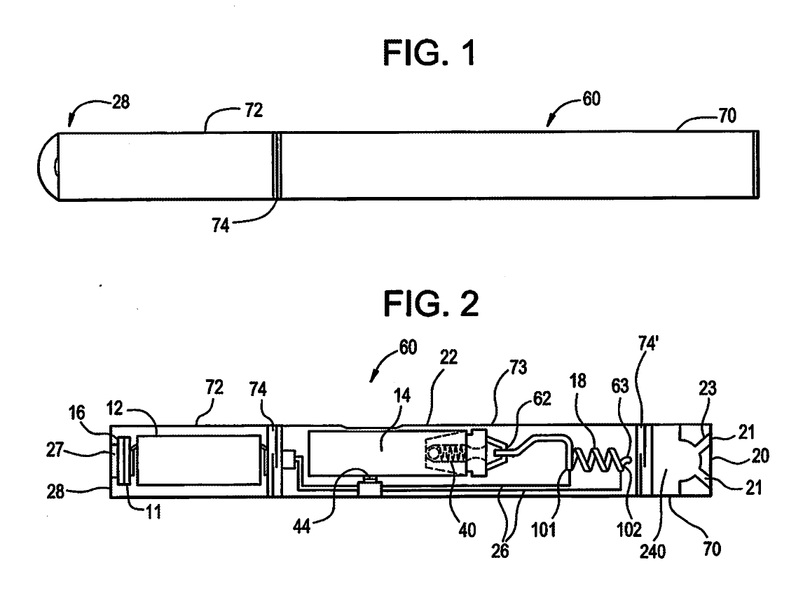

FIG. 1 is a side view of an e-vaping device or a “cigalike” device 60, according to an example embodiment. In FIG. 1, the e-vaping device 60 includes a first section or cartridge 70 and a second section 72, which are coupled together at a threaded joint 74 or by other connecting structure such as a snug-fit, snap-fit, detent, clamp and/or clasp or the like. In at least one example embodiment, the first section or cartridge 70 may be a replaceable cartridge, and the second section 72 may be a reusable section. Alternatively, the first section or cartridge 70 and the second section 72 may be integrally formed in one piece. In at least one embodiment, the second section 72 includes a LED at a distal end 28 thereof.

FIG. 2 is a cross-sectional view of an example embodiment of an e-vaping device. As shown in FIG. 2, the first section or cartridge 70 can house a mouth-end insert 20, a capillary capillary tube 18, and a reservoir 14.

In example embodiments, the reservoir 14 may include a wrapping of gauze about an inner tube (not shown). For example, the reservoir 14 may be formed of or include an outer wrapping of gauze surrounding an inner wrapping of gauze. In at least one example embodiment, the reservoir 14 may be formed of or include an alumina ceramic in the form of loose particles, loose fibers, or woven or nonwoven fibers. Alternatively, the reservoir 14 may be formed of or include a cellulosic material such as cotton or gauze material, or a polymer material, such as polyethylene terephthalate, in the form of a bundle of loose fibers. A more detailed description of the reservoir 14 is provided below.

The second section 72 can house a power supply 12, control circuitry 11 configured to control the power supply 12, and a puff sensor 16. The puff sensor 16 is configured to sense when an adult vaper is drawing on the e-vaping device 60, which triggers operation of the power supply 12 via the control circuitry 11 to heat the pre-vapor formulation housed in the reservoir 14, and thereby form a vapor. A threaded portion 74 of the second section 72 can be connected to a battery charger, when not connected to the first section or cartridge 70, to charge the battery or power supply section 12.

In example embodiments, the capillary tube 18 is formed of or includes a conductive material, and thus may be configured to be its own heater by passing current through the tube 18. The capillary tube 18 may be any electrically conductive material capable of being heated, for example resistively heated, while retaining the necessary structural integrity at the operating temperatures experienced by the capillary tube 18, and which is non-reactive with the pre-vapor formulation. Suitable materials for forming the capillary tube 18 are one or more of stainless steel, copper, copper alloys, porous ceramic materials coated with film resistive material, nickel-chromium alloys, and combinations thereof. For example, the capillary tube 18 is a stainless steel capillary tube 18 and serves as a heater via electrical leads 26 attached thereto for passage of direct or alternating current along a length of the capillary tube 18. Thus, the stainless steel capillary tube 18 is heated by, for example, resistance heating. Alternatively, the capillary tube 18 may be a non-metallic tube such as, for example, a glass tube. In such an embodiment, the capillary tube 18 also includes a conductive material such as, for example, stainless steel, nichrome or platinum wire, arranged along the glass tube and capable of being heated, for example resistively. When the conductive material arranged along the glass tube is heated, pre-vapor formulation present in the capillary tube 18 is heated to a temperature sufficient to at least partially volatilize pre-vapor formulation in the capillary tube 18.

In at least one embodiment, the electrical leads 26 are bonded to the metallic portion of the capillary tube 18. In at least one embodiment, one electrical lead 26 is coupled to a first, upstream portion 101 of the capillary tube 18 and a second electrical lead 26 is coupled to a downstream, end portion 102 of the capillary tube 18.

In operation, when an adult vaper draws on the e-vaping device, the puff sensor 16 detects a pressure gradient caused by the drawing of the adult vaper, and the control circuitry 11 controls heating of the pre-vapor formulation located in the reservoir 14 by providing power to the capillary tube 18. Once the capillary tube 18 is heated, the pre-vapor formulation contained within a heated portion of the capillary tube 18 is volatilized and emitted from the outlet 63, where the pre-vapor formulation expands and mixes with air and forms a vapor in mixing chamber 240.

As shown in FIG. 2, the reservoir 14 includes a valve 40 configured to maintain the pre-vapor formulation within the reservoir 14 and to open when the reservoir 14 is squeezed and pressure is applied thereto, the pressure being created when an adult vaper draws on the e-vaping device at the mouth-end insert 20, which results in the reservoir 14 forcing the pre-vapor formulation through the outlet 62 of the reservoir 14 to the capillary tube 18. In at least one embodiment, the valve 40 opens when a critical, minimum pressure is reached so as to avoid inadvertently dispensing pre-vapor formulation from the reservoir 14. In at least one embodiment, the pressure required to press the pressure switch 44 is high enough such that accidental heating due to the pressure switch 44 being inadvertently pressed by outside factors such as physical movement or collision with outside objects is avoided.

The power supply 12 of example embodiments can include a battery arranged in the second section 72 of the e-vaping device 60. The power supply 12 is configured to apply a voltage to volatilize the pre-vapor formulation housed in the reservoir 14.

In at least one embodiment, the electrical connection between the capillary tube 18 and the electrical leads 26 is substantially conductive and temperature resistant while the capillary tube 18 is substantially resistive so that heat generation occurs primarily along the capillary tube 18 and not at the contacts.

The power supply section or battery 12 may be rechargeable and include circuitry allowing the battery to be chargeable by an external charging device. In example embodiments, the circuitry, when charged, provides power for a given number of puffs, after which the circuitry may have to be re-connected to an external charging device.

In at least one embodiment, the e-vaping device 60 may include control circuitry 11 which can be, for example, on a printed circuit board. The control circuitry 11 may also include a heater activation light 27 that is configured to glow when the device is activated. In at least one embodiment, the heater activation light 27 comprises at least one LED and is at a distal end 28 of the e-vaping device 60 so that the heater activation light 27 illuminates a cap which takes on the appearance of a burning coal during a puff. Moreover, the heater activation light 27 can be configured to be visible to the adult vaper. The light 27 may also be configured such that the adult vaper can activate and/or deactivate the light 27 when desired, such that the light 27 is not activated during vaping if desired.

In at least one embodiment, the e-vaping device 60 further includes a mouth-end insert 20 having at least two off-axis, diverging outlets 21 that are uniformly distributed around the mouth-end insert 20 so as to substantially uniformly distribute vapor in an adult vaper's mouth during operation of the e-vaping device. In at least one embodiment, the mouth-end insert 20 includes at least two diverging outlets 21 (e.g., 3 to 8 outlets or more). In at least one embodiment, the outlets 21 of the mouth-end insert 20 are located at ends of off-axis passages 23 and are angled outwardly in relation to the longitudinal direction of the e-vaping device 60 (e.g., divergently). As used herein, the term “off-axis” denotes an angle to the longitudinal direction of the e-vaping device.

In at least one embodiment, the e-vaping device 60 is about the same size as a tobacco-based product. In some embodiments, the e-vaping device 60 may be about 80 mm to about 110 mm long, for example about 80 mm to about 100 mm long and about 7 mm to about 10 mm in diameter.

The outer cylindrical housing 22 of the e-vaping device 60 may be formed of or include any suitable material or combination of materials. In at least one embodiment, the outer cylindrical housing 22 is formed at least partially of metal and is part of the electrical circuit connecting the control circuitry 11, the power supply 12 and the puff sensor 16.

As shown in FIG. 2, the e-vaping device 60 can also include a middle section (third section) 73, which can house the pre-vapor formulation reservoir 14 and the capillary tube 18. The middle section 73 can be configured to be fitted with a threaded joint 74′ at an upstream end of the first section or cartridge 70 and a threaded joint 74 at a downstream end of the second section 72. In this example embodiment, the first section or cartridge 70 houses the mouth-end insert 20, while the second section 72 houses the power supply 12 and the control circuitry 11 that is configured to control the power supply 12.

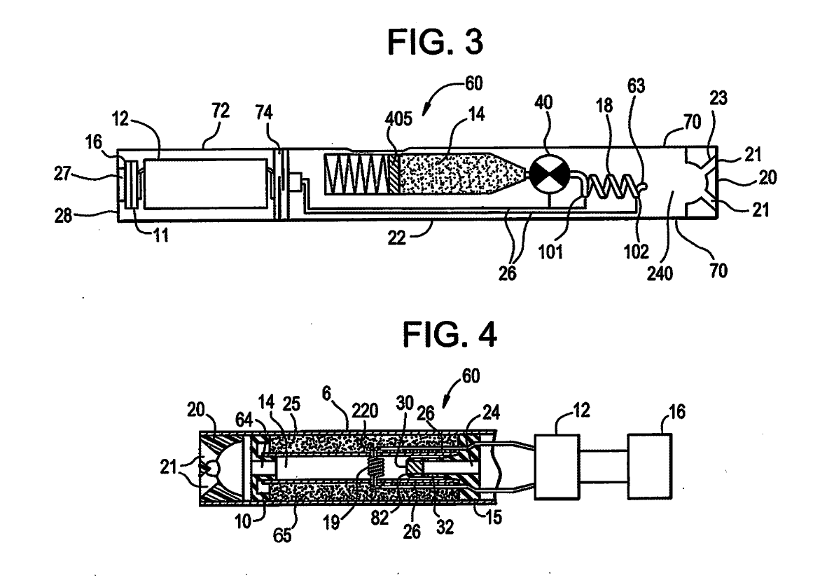

FIG. 3 is a cross-sectional view of an e-vaping device according to an example embodiment. In at least one embodiment, the first section or cartridge 70 is replaceable so as to avoid the need for cleaning the capillary tube 18. In at least one embodiment, the first section or cartridge 70 and the second section 72 may be integrally formed without threaded connections to form a disposable e-vaping device.

As shown in FIG. 3, in other example embodiments, a valve 40 can be a two-way valve, and the reservoir 14 can be pressurized. For example, the reservoir 14 can be pressurized using a pressurization arrangement 405 configured to apply constant pressure to the reservoir 14. As such, emission of vapor formed via heating of the pre-vapor formulation housed in the reservoir 14 is facilitated. Once pressure upon the reservoir 14 is relieved, the valve 40 closes and the heated capillary tube 18 discharges any pre-vapor formulation remaining downstream of the valve 40.

FIG. 4 is a longitudinal cross-sectional view of another example embodiment of an e-vaping device. In FIG. 4, the e-vaping device 60 can include a central air passage 24 in an upstream seal 15. The central air passage 24 opens to the inner tube 65. Moreover, the e-vaping device 60 includes a reservoir 14 configured to store the pre-vapor formulation. The reservoir 14 includes the pre-vapor formulation and optionally a storage medium 25 such as gauze configured to store the pre-vapor formulation therein. In an embodiment, the reservoir 14 is contained in an outer annulus between the outer tube 6 and the inner tube 65. The annulus is sealed at an upstream end by the seal 15 and by a stopper 10 at a downstream end so as to prevent leakage of the pre-vapor formulation from the reservoir 14. The heater 19 at least partially surrounds a central portion of a wick 220 such that when the heater is activated, the pre-vapor formulation present in the central portion of the wick 220 is vaporized to form a vapor. The heater 19 is connected to the battery 12 by two spaced apart electrical leads 26. The e-vaping device 60 further includes a mouth-end insert 20 having at least two outlets 21. The mouth-end insert 20 is in fluid communication with the central air passage 24 via the interior of inner tube 65 and a central passage 64, which extends through the stopper 10.

The e-vaping device 60 may include an air flow diverter comprising an impervious plug 30 at a downstream end 82 of the central air passage 24 in seal 15. In at least one example embodiment, the central air passage 24 is an axially extending central passage in seal 15, which seals the upstream end of the annulus between the outer and inner tubes 6, 65. The radial air channel 32 directing air from the central passage 20 outward toward the inner tube 65. In operation, when an adult vaper draws on the e-vaping device and creates a negative pressure, the puff sensor 16 detects a pressure gradient caused by the drawing of the adult vaper on the mouth-end insert of the e-vaping device, thereby creating a negative pressure, and as a result the control circuitry 11 controls heating of the pre-vapor formulation located in the reservoir 14 by providing power the heater 19.

In one example embodiment, the pre-vapor formulation includes at least one additive such as a polyol, which may be, for example, mannitol, erythritol, xylithol and/or sorbitol, and may also include nicotine, a combination of glycerol and/or propylene glycol, optionally flavorants as well as organic acids, optionally water, and the like. In example embodiments, the polyol additive may be included in the pre-vapor formulation at a concentration of, for example about 0.2% to about 10%, and for example about 0.2% to about 2%, about 2% to about 5%, about 5% to about 8%, and about 8% to about 10%.

In example embodiments, the addition of the polyol additive such as, for example, mannitol, erythritol, xylithol and/or sorbitol, to the pre-vapor formulation of an e-vaping device may increase the stability of the various other ingredients present in the pre-vapor formulation, may reduce or substantially prevent the oxidation of the solid portions of the e-vaping device, such as the cartridge, that may come in contact with the ingredients of the pre-vapor formulation, and may substantially prevent the transfer of free radicals including hydroxyl radicals into the vapor generated by the e-vaping device. Thus, the addition of a polyol additive, which may be soluble in glycerol, propylene glycol or water and may be added in amounts that are effective, can increase the stability of the various ingredients present in the pre-vapor formulation.

In example embodiments, because the oxidation of ingredients of the pre-vapor formulation results from the generation of hydroxyl radicals generated from oxygen or hydrogen peroxide (H₂O₂) formed from oxygen in the presence of redox-active transition metals, the addition of the polyol compounds, which are scavengers or neutralizers of hydroxyl radicals in the pre-vapor formulation. Accordingly, oxidation of ingredients of the pre-vapor formulation due to the presence of the hydroxyl radicals is reduced or substantially prevented and the stability of the ingredients present in the pre-vapor formulation is increased.

In an example embodiment, the pre-vapor formulation may also include chelating agents, in addition to the mixture of nicotine, water, propylene glycol and/or glycerol, polyol compounds, and potentially organic acids. The presence of the chelating agents and ion exchangers may bind all of the redox active free transition metals and the oxygen, thus limiting free radical formation including hydroxyl radicals. During operation of the e-vaping device, the polyol compounds present in the pre-vapor formulation may react with most or a majority of any remaining free radicals such as hydroxyl radicals. For example, the ion exchange agents may include soluble polyelectrolyte polymers with a functional group, such as carboxylic acid groups, sulfonic acid groups such as sulphonated polystyrene, quaternary amino groups such as trimethyl ammonium, and other amino groups. As a result of the combined action of the polyols, the chelating agents and the ion exchange agents, free radicals such as OH radicals or free radicals formed by pre-vapor formulation ingredients reacting with OH radicals are substantially prevented from transferring into the vapor generated during operation of the e-vaping device.

During operation of an e-vaping device, the acids typically protonate the molecular nicotine in the pre-vapor formulation, so that upon heating of the pre-vapor formulation by a heater in the cartridge of the e-vaping device, a vapor having a majority amount of protonated nicotine and a minority amount of unprotonated nicotine is produced, whereby only a minor portion of all the volatilized (vaporized) nicotine typically remains in the gas phase of the vapor. For example, although the pre-vapor formulation may include up to 5% of nicotine, the proportion of nicotine in the gas phase of the vapor may be substantially 1% or less of the total nicotine delivered.

In some example embodiments, the polyol compounds are soluble in the pre-vapor formulation. For example, the polyol compounds are soluble in water, in propylene glycol or in glycerol.

According to at least one example embodiment, the acids present in the pre-vapor formulation have the ability to transfer into the vapor. Transfer efficiency of an acid is the ratio of the mass fraction of the acid in the vapor to the mass fraction of the acid in the liquid. In at least one embodiment, the acid or combination of acids present in the pre-vapor formulation have a liquid to vapor transfer efficiency of about 50% or greater, and for example about 60% or greater. For example, pyruvic acid, tartaric acid and acetic acid have vapor transfer efficiencies of about 50% or greater.

In at least one embodiment, the acid(s) present in the pre-vapor formulation are in an amount sufficient to reduce the amount of nicotine gas phase portion by about 30% by weight or greater, by about 60% to about 70% by weight, by about 70% by weight or greater, or by about 85% by weight or greater, of the level of nicotine gas phase portion produced by an equivalent pre-vapor formulation that does not include the acid(s).

According to at least one example embodiment, the acid(s) present in the pre-vapor formulation include one or more of pyruvic acid, formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid, sulfuric acid, and combinations thereof. The pre-vapor formulation may also include a vapor former, optionally water, and optionally flavorants.

In at least one embodiment, the vapor former is one of propylene glycol, glycerin and combinations thereof. In another embodiment, the vapor former is glycerin. In at least one embodiment, the vapor former is included in an amount ranging from about 40% by weight based on the weight of the pre-vapor formulation to about 90% by weight based on the weight of the pre-vapor formulation (e.g., about 50% to about 80%, about 55% to about 75% or about 60% to about 70%). Moreover, in at least one embodiment, the pre-vapor formulation can include propylene glycol and glycerin included in a ratio of about 3:2. In at least one embodiment, the ratio of propylene glycol and glycerin may be substantially 2:3 and 3:7.

The pre-vapor formulation optionally includes water. Water can be included in an amount ranging from about 5% by weight based on the weight of the pre-vapor formulation to about 40% by weight based on the weight of the pre-vapor formulation, or in an amount ranging from about 10% by weight based on the weight of the pre-vapor formulation to about 15% by weight based on the weight of the pre-vapor formulation.

The acid(s) present in the pre-vapor formulation may have a boiling point of at least about 100° C. For example, the acid(s) may have a boiling point ranging from about 100° C. to about 300° C., or about 150° C. to about 250° C. (e.g., about 160° C. to about 240° C., about 170° C. to about 230° C., about 180° C. to about 220° C. or about 190° C. to about 210° C.). By generating acids having a boiling point within the above ranges, the acids may volatilize when heated by the heater element of the e-vaping device. In at least one example embodiment utilizing a heater coil and a wick, the heater coil may reach an operating temperature at or about 300° C.

The total content of acid(s) present in the pre-vapor formulation may range from about 0.1% by weight to about 6% by weight, or from about 0.1% by weight to about 2% by weight, based on the weight of the pre-vapor formulation. The pre-vapor formulation may also contain between up to 3% and 5% nicotine by weight. In at least one embodiment, the total generated acid content of the pre-vapor formulation is less than about 3% by weight. In another embodiment, the total generated acid content of the pre-vapor formulation is less than about 0.5% by weight. The pre-vapor formulation may also contain between about 4.5% and 5% nicotine by weight. When tartaric acid, pyruvic acid, and/or acetic acid is present, the total acid content of the pre-vapor formulation may be about 0.05% by weight to about 2% by weight, or about 0.1% by weight to about 1% by weight.

The pre-vapor formulation may also include a flavorant in an amount ranging from about 0.01% to about 15% by weight (e.g., about 1% to about 12%, about 2% to about 10%, or about 5% to about 8%). The flavorant can be a natural flavorant or an artificial flavorant. In at least one embodiment, the flavorant is one of tobacco flavor, menthol, wintergreen, peppermint, herb flavors, fruit flavors, nut flavors, liquor flavors, and combinations thereof.

In embodiments, the nicotine is included in the pre-vapor formulation in an amount ranging from about 2% by weight to about 6% by weight (e.g., about 2% to about 3%, about 2% to about 4%, about 2% to about 5%) based on the total weight of the pre-vapor formulation. In at least one embodiment, the nicotine is added in an amount of up to about 5% by weight based on the total weight of the pre-vapor formulation. In at least one embodiment, the nicotine content of the pre-vapor formulation is about 2% by weight or greater based on the total weight of the pre-vapor formulation. In another embodiment, the nicotine content of the pre-vapor formulation is about 2.5% by weight or greater based on the total weight of the pre-vapor formulation. In another embodiment, the nicotine content of the pre-vapor formulation is about 3% by weight or greater based on the total weight of the pre-vapor formulation. In another embodiment, the nicotine content of the pre-vapor formulation is about 4% by weight or greater based on the total weight of the pre-vapor formulation. In another embodiment, the nicotine content of the pre-vapor formulation is about 4.5% by weight or greater based on the total weight of the pre-vapor formulation.

In example embodiments, a concentration of the nicotine in the vapor phase of the pre-vapor formulation is equal to or smaller than substantially 1% by weight. Also in example embodiments, the acid(s) include at least one of pyruvic acid, formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid and sulfuric acid.

Example embodiments having thus been described, it will be obvious that the same may be varied in many ways. Such variations are not to be regarded as a departure from the intended spirit and scope of example embodiments, and all modifications as would be obvious to one skilled in the art are intended to be included within the scope of the following claims.

What is claimed is:

1. A pre-vapor formulation of an e-vaping device, the pre-vapor formulation comprising:
at least one polyol compound and one chelating agent;
nicotine; and
a vapor former configured to form a vapor of the pre-vapor formulation.

2. The pre-vapor formulation of claim 1, wherein the at least one polyol compound comprises at least one of mannitol, erythritol, xylithol and sorbitol.

3. The pre-vapor formulation of claim 1, wherein the at least one chelating agent comprises at least one of EDTA, DTPA and NTA.

4. The pre-vapor formulation of claim 1, wherein a concentration of the at least one polyol compound is equal to or greater than about 0.2% and equal to or smaller than about 10% by weight.

5. The pre-vapor formulation of claim 4, wherein the concentration of the one or more polyol compounds is equal to or greater than about 0.2% and equal to or smaller than about 5% by weight.

6. The pre-vapor formulation of claim 5, wherein the concentration of the one or more polyol compounds is equal to or greater than about 5% and equal to or smaller than about 8% by weight.

7. The pre-vapor formulation of claim 5, wherein the concentration of the one or more polyol compounds is equal to or greater than about 8% and equal to or smaller than about 10% by weight.

8. The pre-vapor formulation of claim 1, wherein the concentration of the one or more chelating agents is equal to or greater than about 0.001% and equal to or smaller than about 0.05% by weight.

9. The pre-vapor formulation of claim 8, wherein the concentration of the one or more chelating agents is equal to or greater than about 0.001% and equal to or smaller than about 0.01% by weight.

10. The pre-vapor formulation of claim 8, wherein the concentration of the one or more chelating agents is equal to or greater than about 0.01% and equal to or smaller than about 0.02% by weight.

11. The pre-vapor formulation of claim 8, wherein the concentration of the one or more chelating agents is equal to or greater than about 0.02% and equal to or smaller than about 0.05% by weight.

12. The pre-vapor formulation of claim 1, wherein a concentration of the nicotine in a vapor phase of the pre-vapor formulation is equal to or smaller than substantially 1% by weight.

13. The pre-vapor formulation of claim 1, wherein the pH of the pre-vapor formulation is between about 4 and about 6.

14. The pre-vapor formulation of claim 1, further comprising at least one or more acids.

15. The pre-vapor formulation of claim 14 wherein the one or more acids comprise at least one of formic acid, oxalic acid, glycolic acid, acetic acid, isovaleric acid, valeric acid, propionic acid, octanoic acid, lactic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid and sulfuric acid.

16. An e-vaping device, comprising:
a cartridge including a pre-vapor formulation and a heater configured to heat the pre-vapor formulation; and
a power source coupled to the cartridge and configured to supply power to the heater;
wherein the pre-vapor formulation includes:
at least one polyol compound and one chelating agent;
nicotine; and
a vapor former configured to form a vapor of the pre-vapor formulation.

17. The e-vaping device of claim 16, wherein the at least one polyol compound comprises at least one of mannitol, erythritol, xylithol and sorbitol.

18. The e-vaping device of claim 16, wherein the at least one chelating agents comprises at least one of EDTA, DTPA and NTA.

19. The e-vaping device of claim 16, wherein the concentration of the at least one polyol compound is equal to or greater than about 0.2% and equal to or smaller than about 10% by weight.

20. The e-vaping device of claim 16, wherein the concentration of the one or more chelating agents is equal to or greater than about 0.001% and equal to or smaller than about 0.05% by weight.

21. The pre-vapor formulation of claim 1, further comprising a soluble polyelectrolyte polymer with at least one functional group of poly-(acrylic acid, sulfonic acid) groups and poly-(quaternary ammonium) groups.
